(19) United States
(12) Patent Application Publication
(10) Pub. No.: US 2014/0268883 A1
(43) Pub. Date: Sep. 18, 2014

(54) NIGHT LAMP WITH ROTARY DECORATION

(71) Applicant: Chin-Sheng YANG, Tainan City (TW)

(72) Inventor: Chin-Sheng YANG, Tainan City (TW)

(21) Appl. No.: 13/798,164

(22) Filed: Mar. 13, 2013

(51) Int. Cl. F21V 1/00

(52) U.S. Cl. CPC F21V 1/00
USPC 362/644

(57) ABSTRACT

The present invention provides a night lamp with rotary decoration. The night lamp includes a main body, which includes electrical pins for connection with an electric main to receive electrical power and is provided with a light-emitting element electrically connected to the main body; a lampshade, which is of a three-dimensional configuration fixed to a top portion of the main body and includes a mount extending from a front side thereof to support a rotation mechanism mounted thereon; and a decoration, which is of a three-dimensional configuration and has a bottom coupled to the rotation mechanism so that the rotation mechanism, through releasing potential stored therein, drives the decoration to rotate so as to provide the night lamp with a different visual perception.

### (a) TECHNICAL FIELD OF THE INVENTION

The present invention generally relates to a night lamp, and more particularly to a night lamp having dual functions of illumination and dynamic visual entertainment effect.

### (b) DESCRIPTION OF THE PRIOR ART

A night lamp is commonly used to provide illumination for nighttime or for a dark indoor corner, so that when people walk around, they will not undesirably collide or kick any object and get hurt. Further, a night lamp also has a function of creating a romantic environment. Thus, manufacturers are devoted themselves to developing and manufacturing lampshades of various unique shapes.

Although a night lamp may be used to create a romantic environment, yet the lampshade of the night lamp is often integrally formed as a unitary piece and thus provides only a static function of beautiful appearance for visual watching for amusement. Thus, the design of night lamp is now a special topic for the manufacturers of environmental lighting devices.

In view of this, the present invention aims to provide a night lamp that features dual functions of illumination and visual entertainment effect.

### SUMMARY OF THE INVENTION

Thus, the present invention provides a night lamp with rotary decoration, which comprises:

a main body, which comprises a casing receiving therein a circuit assembly, the main body having a side surface on which electrical pins that are provided to connect with an electric main to receive electrical power;

a light-emitting element, which is mounted on the main body and is electrically connected to the main body;

a lampshade, which is of a three-dimensional configuration fixed to a top portion of the main body, the lampshade comprising a mount extending from a front side thereof, the mount comprising a rotation mechanism mounted thereon; and

a decoration, which is of a three-dimensional configuration and has a bottom that is coupled to the rotation mechanism.

The present invention features a mount extending from a front side of a lampshade for supporting a rotation mechanism and a decoration mounted thereon so that when the rotation mechanism is twisted, potential energy is built up and stored therein and when the potential energy is released, the decoration is driven to rotate so as to enhance amusement provided by the night lamp.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an embodiment of the present invention.

FIG. 2 is an exploded view of the present invention.

FIG. 3 is an exploded view showing another embodiment of the present invention.

FIG. 4 is a perspective view of said another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIGS. 1 and 2, which are respectively a perspective view and an exploded view the present invention, the present invention provides a nigh lamp 1 that is provided with a rotary decoration. The night lamp 1 comprises a main body 11, which is a casing receiving therein a circuit assembly. The main body 11 has a side surface on which electrical pins 12 that are provided for connection with an electric main to receive electrical power. The main body 11 also comprises a switch 13, which is of a known design of electronics so that further details are omitted herein.

A light-emitting element 14 is mounted atop the main body 11 and is electrically connected via the switch 13 to the electrical pins 12 so as to be controlled by the switch 13 for lighting on/off. The light-emitting element 14 is not limited to any specific type and can be a light bulb or a light-emitting diode, just naming a few examples.

A lampshade 15 is of a light-transmitting three-dimensional configuration. The lampshade 15 has a bottom forming an opening 16 that is fit to and fixed to a top portion of the main body. The lampshade 15 comprises a mount 17 extending from a front side thereof. The mount 17 carries a rotation mechanism 18 mounted thereon.

A decoration 19 is of a three-dimensional configuration and in the embodiment illustrated, a snowman is taken as an example for illustration, yet the present invention is not limited to any specific configuration. The decoration 19 has a bottom that is coupled to the rotation mechanism so that the rotation mechanism 18 may drive the decoration 19 to rotate by releasing energy stored therein through a winding/rotation operation.

In the instant embodiment, the rotation mechanism 18 comprises a coil spring 181, a rotation shaft 182, and a driven gear 183. The coil spring 181 has an end fixed to the mount 17 and an opposite end coupled to the rotation shaft 182. The rotation shaft 182 carries a driving gear 184 that engages the driven gear 183. The driven gear 183 has a top surface from which a coupling seat 185 extends to couple the decoration 19.

When the rotation shaft 182 is rotated, potential energy is built up and stored in the coil spring 181. The potential energy stored in the coil spring 181 can be selectively released to drive the driving gear 184 to rotate and the driving gear 184 in turn drives the driven gear 183 to rotate so as to make the decoration 19 coupled to the coupling seat 185 rotating, thereby improving amusement of the night lamp 1.

The coupling seat 185 is arranged to be coaxial with the driven gear 183, whereby when the driven gear 183 is driven to rotate, the decoration 19 that is coupled to the coupling seat 185 is caused to spin and kept at the same site. Referring to FIGS. 3 and 4, another embodiment of the present invention is shown, in which the coupling seat 185 is mounted at a location close to a circumference of the driven gear 183 and the mount 17 comprises a track 20. When the driven gear 183 is driven to rotate, the coupling seat 185 and the decoration 19 are caused to do an orbital movement around a center of the driven gear 183. This arrangement provides the night lamp 1 with a different visual perception.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A night lamp, comprising:
a main body, which comprises a casing receiving therein a circuit assembly, the main body having a side surface on which electrical pins that are adapted to connect with an electric main to receive electrical power;
a light-emitting element, which is mounted on the main body and is electrically connected to the main body;
a lampshade, which is of a three-dimensional configuration fixed to a top portion of the main body, the lampshade comprising a mount extending from a front side thereof, the mount comprising a rotation mechanism mounted thereon; and
a decoration, which is of a three-dimensional configuration and has a bottom that is coupled to the rotation mechanism so that the rotation mechanism, through releasing potential stored therein, drives the decoration to rotate.

2. The night lamp according to claim 1, wherein the rotation mechanism comprises a coil spring, a rotation shaft, and a driven gear, the rotation shaft being adapted to be rotated for twisting the coil spring and comprising a driving gear mating the driven gear.

3. The night lamp device according to claim 2, wherein the driven gear comprises a coupling seat extending therefrom to couple to the decoration.

4. The night lamp according to claim 3, wherein the coupling seat is coaxial with the driven gear.
